(19) United States
(12) Patent Application Publication
(10) Pub. No.: US 2025/0065554 A1
(43) Pub. Date: Feb. 27, 2025

(54) METHOD FOR MANUFACTURING A COMPOSITE FILAMENT AND USE THEREOF

(71) Applicant: LUXEMBOURG INSTITUTE OF SCIENCE AND TECHNOLOGY (LIST), Esch-Sur-Alzette (LU)

(72) Inventors: Henri PERRIN, Esch-Sur-Alzette (LU); Loïc BORGHINI, Esch-Sur-Alzette (LU); Sébastien KLEIN, Esch-Sur-Alzette (LU)

(21) Appl. No.: 18/726,018

(22) PCT Filed: Dec. 27, 2022
(86) PCT No.: PCT/EP2022/087860

§ 371 Date: Jul. 1, 2024

(30) Foreign Application Priority Data
Dec. 29, 2021 (LU) LU501121

(51) Int. Cl. B29C 48/154; B29B 15/12; B29B 15/14; B29C 70/38; B29K 33/04; B29K 307/04

(52) U.S. Cl. CPC B29C 48/154; B29B 15/122; B29B 15/14; B29C 70/382; B29K 2033/04; B29K 2307/04

(57) ABSTRACT

A method for manufacturing a composite filament aimed to an additive manufacturing application or a winding application, the method comprising, in the following order: providing a thread of fibers; impregnating the thread with a liquid reactive thermoplastic resin; co-extruding a sheath of thermoplastic material around the impregnated thread; and curing the thermoplastic resin. Additionally, a filament obtained at least partly by the method, the use of the filament for manufacturing a product obtained by an additive manufacturing or by a winding technique, and a machine for performing the method, thereby enabling a high-speed production (e.g., 10 meters per minute) of a filament of high quality.

### CROSS-REFERENCE TO RELATED APPLICATIONS

The present invention is the US national stage under 35 U.S.C. § 371 of International Application No. PCT/EP2022/087860 filed on Dec. 27, 2022, which claims the priority of application LU501121 filed on Dec. 29, 2021, the contents of which (text, drawings and claims) are incorporated here by reference in their entirety.

### FIELD

The invention relates to the field of composite materials that can be used in additive manufacturing or in winding applications.

In particular, the invention relates to composite materials used for the manufacturing of parts and structures, such as lightweight structures used in automotive, aircraft or space industry.

### BACKGROUND

Composite filaments that are made from a thread or a roving of fibers, especially carbon fibers, are known from prior art under the name of continuous fiber reinforced filaments or prepregs.

In fact, composite filaments are commonly used to form 3D-printed parts by additive manufacturing processes wherein the part is formed from successive layers created by melting the filament. On the other hand, composite filaments can also have the form of a tape especially when used in a winding process, also called weaving process. In a winding process, a composite structure is formed by winding the tape using a robotized machine.

It is known from the state of the art that the roving is impregnated using a binder. For instance, a thermosetting binder based on a thermoset resin is commonly used to impregnate the thread of carbon fibers.

However, the thermoset resin presents considerable material formability limitations, especially when heated, inducing cracks during the printing operation.

In fact, the impregnating binder of the composite filament needs to be fully cured before the filament being usable in an additive manufacturing process. For that purpose, it is known from the art to use an oven configured to heat the thermoset resin to temperatures rising up to 400° C. However, in order to fully cure the thermoset binder, it usually needs around 10 min of total curing time, and knowing that the process time is dependent on the curing time, the slow curing process results in a slow filament production rate, typically having a speed ranging from 0.3 m/min to 1 m/min. Added to that, technical analysis has been carried out which supports that this method of curing a thermoset resin induces high number of voids and a random filament section.

Another disadvantage of using a thermoset resin-based binder for impregnating the composite filament, is the limited physicochemical compatibility between the filament and other thermoplastic materials used in a later stage of the forming process, i.e., 3D printing or overmolding. This insufficient compatibility results in a poor filament morphological quality during the additive manufacturing process and the 3D-printed part using that filament usually demonstrates mechanical properties which may not be seen as sufficient for every application.

In fact, a weak adhesion between the thermoset based continuous fiber reinforced filament and the thermoplastic polymer is observed during the 3D printing process. A relative motion (sliding) of the filament with respect to the resin can even be observed. This may impact the mechanical resistance of the final product and/or its longevity.

Publication document WO 2017/188861 A1 discloses an example of such known techniques. A prepreg which is considered as a commodity polymer is produced with the impregnation of fibers using a full bath of liquid thermoset resin coupled with curing using an oven. The production rate of the composite filament depends on curing time, which constitutes an intrinsic technological limit of productivity.

The filament disclosed in the document WO 2017/188861 A1 also presents limits of material formability and a limited production rate due to the curing time of the epoxy matrix. In fact, the filament is generated at a speed of around 1 m/min which leaves some margin for improvement. In addition, the question of multi-material assembly during the additive manufacturing process is not solved.

### SUMMARY OF INVENTION

The present invention addresses the above-mentioned deficiencies and aims at providing a composite filament with a superior hot formability and a better compatibility with a large range of technical polymers during additive manufacturing for facilitating the 3D-printing or winding processes.

The invention further aims at providing a manufacturing method for the filament with a higher production speed.

Overall, the present invention enables to manufacture products of higher quality in a shorter amount of time.

The above-stated problem is solved by a composite filament manufacturing method aimed to an additive manufacturing application or a winding application, the method comprising, in the following order: providing a thread of fibers; impregnating the thread with a liquid reactive thermoplastic resin; co-extruding a sheath of thermoplastic material around the impregnated thread; and curing the thermoplastic resin.

The co-extrusion of a sheath enables to produce a filament without having to wait for the impregnation resin to cure, thereby waiving the time constraint of known methods. Also, the sheath improves the homogeneity and cross-section profile of the filament.

According to an exemplary embodiment, the method further comprises a step of solidifying the sheath at least partially before curing the thermoplastic resin. The polymerization of the sheath can optionally overlap the polymerization of the resin, meaning that the sheath can still be solidifying while the filament enters an oven for curing the resin. The polymerization of the resin is controlled and a chemical diffusion of the resin into the sheath occurs, thereby creating a chemical and mechanical bond.

According to an exemplary embodiment, the sheath material is extruded at a rate of about 10 meters per minute. “about” is intended to mean plus or minus 20% of the given value. This production rate is made possible by the fact that the resin does not need to be totally cured when the filament reaches the winding coil at the end of the manufacturing line. This production rate results roughly in the production of a coil of 5000 meters over a duration of 8 hours.

According to an exemplary embodiment, the thermoplastic resin is cured at a temperature that is lower than the melting temperature of the sheath, the former being in various instances around 100° C. while the latter is in various instances around 200°° C. “around” is intended to mean plus or minus 10% of the given values. This ensures that the sheath is not altered in shape or structure during curing of the resin.

According to an exemplary embodiment, the sheath material is a blend of thermoplastic polymers, which harden at room temperature. This blend enables a good physicochemical adhesion both with the impregnating resin of the filament and with an additional thermoplastic resin that can be used during the 3D printing process.

According to an exemplary embodiment, the liquid reactive thermoplastic resin is mainly composed of (meth)acrylic monomer and polymer syrup in presence of organic peroxides. This resin enables impregnation at room temperature, and has a good ratio of mechanical resistance per unit weight. This resin is a liquid resin having a thermoplastic behavior.

According to an exemplary embodiment, the thread is made of dry carbon fibers.

According to an exemplary embodiment, the co-extrusion is carried out with an extrusion nozzle having a circular or polygonal cross-section. Since the present invention enables to obtain a homogenous filament, the invention allows to depart from the regular purely circular cross-section and various shapes of cross-sections can be envisaged while still ensuring a good control of the quality of the end product.

The invention also relates to a filament obtained at least partly by the method according to any of the above-mentioned embodiments. As explained further in details below, a filament obtained by the method of the invention is structurally distinct from a filament obtained by another method.

The invention also relates to a use of the filament of the preceding paragraph for manufacturing a product by an additive manufacturing or by a winding technique. As mentioned above, the manufacturing process is facilitated by the various materials used, the formability and the homogeneity of the filament.

The invention also relates to a product obtained by the use of the filament. As explained further in details below, a product obtained with the filament of the invention is structurally distinct from a product obtained otherwise. In this regard, strain tests can further support the distinction.

The invention also relates to a machine for producing a composite filament comprising a spool holder containing a thread, an impregnator that impregnates the thread with a thermoplastic resin, an extruder for co-extruding a sheath of thermoplastic material around the uncured impregnated thread, an oven for curing the thermoplastic resin, as well as a puller for pulling the filament through all the elements of the machine, and a winder for winding the filament at a rate of about 10 meters per minute. The co-extrusion of the sheath on an uncured resin enables the high winding rate of 10 meters per minute, ensuring to obtain a filament of high quality at a high production rate.

According to an exemplary embodiment, the impregnator comprises a chamber having an air outlet gate for evacuating air during the impregnation. This air outlet gate avoids air bubbles to remain within the resin, and helps the resin to impregnate all cavities around the fibers, thereby positively impacting the homogeneity of the filament.

According to an exemplary embodiment, the extruder comprises a conical inlet for scrapping the excess of resin. Scrapping the excess of resin enable a better control of the overall process (amount of resin, shape of the cross-section) and homogeneity of the filament.

The co-extrusion of a sheath on an uncured resin enables a combination of chemical and mechanical interlocking, ensuring higher adhesion properties for the filament.

The composite filament improves the compatibility with a large range of polymers during additive manufacturing by tailoring the co-extruded sheath material.

### BRIEF DESCRIPTION OF THE DRAWINGS

FIG. 1 is a schematic representation of a machine for composite filament manufacturing according to prior art.

FIG. 2 is a cross section of a composite filament according to the invention.

FIG. 3 is a schematic representation of a method for manufacturing the composite filament.

FIG. 4 is a schematic representation of a machine for composite filament manufacturing according to the invention.

FIG. 5 is an illustration of a 3D printing application of the composite filament.

FIG. 6 shows a comparison of micrograph cross sections between a filament from prior art and the filament according to the invention.

FIG. 7 is a hot formability comparison graph between the filament of prior art and the filament of the invention.

FIG. 8 is a flexural stress comparison graph between the filament of prior art and the filament of the invention.

FIG. 9 is an interlaminar shear stress comparison graph between the filament of prior art and the filament of the invention.

### DETAILED DESCRIPTION

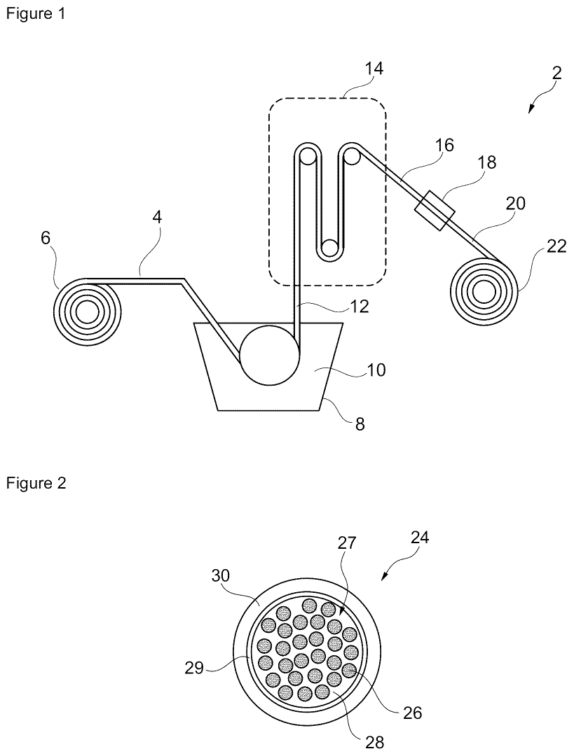

FIG. 1 is a schematic representation of a machine 2 for composite filament manufacturing according to prior art, wherein a roving 4 of reinforcing fibers is unrolled from a spoon or bobbin 6. The roving 4 is then impregnated in a bath 8 with a thermoset resin-based binder 10 and the impregnated roving 12 goes through a complete curing step in an oven 14.

For this purpose, temperatures in the oven 14 range from 70° C. to 400° C. depending on the composition of the thermosetting binder. The curing time takes about 5 to 10 minutes. After curing of the thermosetting binder, the impregnated roving 12 becomes a cured roving 16 which is coated afterwards with a thermoplastic coat. Coating is made using a coating applicator 18 in which thermoplastics are applied to the surface of the cured roving 16, thus forming a finished composite filament 20 received in a bobbin 22.

The known technique illustrated in FIG. 1 results in a filament that has many drawbacks as discussed above. In short, the known technique requires full curing of the filament before winding which restraints the production rate of the filament. The homogeneity and cross-section profile of the filament can be improved.

In contrast, FIG. 2 shows a cross-section (not to scale) of a composite filament 24 according to the invention.

In reference to FIG. 2, the illustrated cross section displays several fibers 26 that are, in various instances, mainly dry carbon fibers forming a (continuous) thread containing a number of fibers ranging in various instances from 1000 to 3000. However, the number of fibers comprised in the filament 24 can be less than 1000 fibers or it can extend beyond 3000 fibers. Fibers can comprise any of the following list: carbon fibers, glass fibers, aramid fibers (kevlar), silicon carbide fibers, vegetable fibers (flax, hemp, etc.), polyester fibers (such as textilene), basalt fibers, or any metallic continuous fiber.

On another note, the fibers 26 are impregnated by a resin-based binder 28, which is a liquid reactive thermoplastic resin 28, also called impregnating matrix material 28. The impregnated fibers 26 form an impregnated thread 27. In various instances, the liquid reactive thermoplastic resin 28 of the impregnated thread 27 is an acrylic resin, for example it is a (meth)acrylic monomer-polymer syrup in presence of a mix of initiators, like organic peroxides, enabling fast curing, e.g., a curing duration of 3 minutes at 110° C.

The filament 24 comprises a co-extruded sheath 30 that is completely and directly wrapping the impregnated fibers 27, the sheath 30 is made of a sheath material which is mainly made of thermoplastics, composed of (meth)acrylic polymer and a similar thermoplastic material used for the 3D printing co-extrusion, e.g., Poly(methyl methacrylate) (PMMA). In various instances, the sheath material is a blend of a plurality of thermoplastic polymers mixed together and configured to be co-extruded by means of a single screw extruder.

The cross section of FIG. 2 further displays an interphase 29 formed by a portion of both the thermoplastic resin 28 and the sheath material 30, the portions have been blended together forming the interpenetrated area 29 around the fibers 26. The filament of the invention differs from the filament known through the specific materials employed for the invention as well as through this interphase 29. Both constitute structural measurables differences between the filament of the invention and a filament of prior art. This interphase 29 results from the fact that the resin and the sheath material are in contact with each other when being both in a (semi)liquid phase. Chemical and mechanical bond ensue.

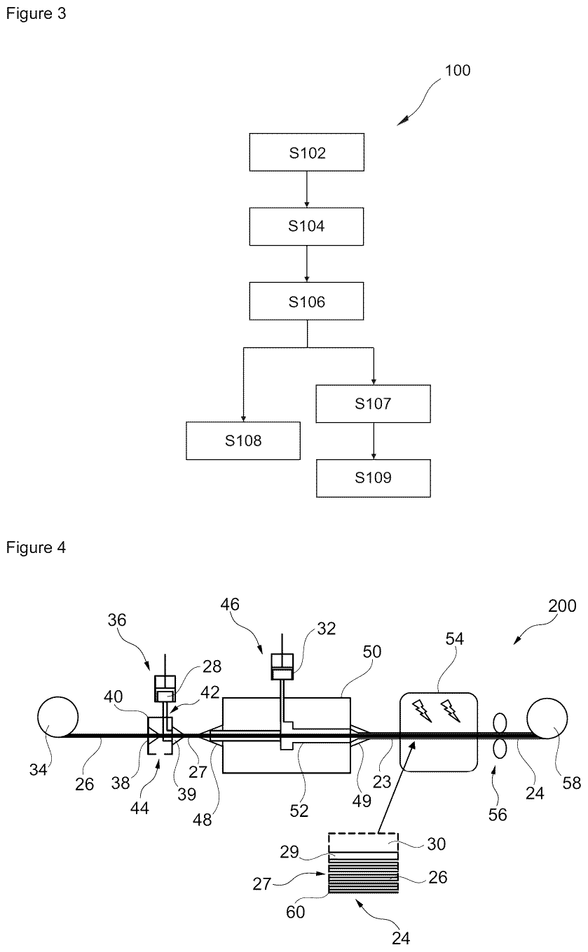

FIG. 3 is a schematic representation of a method 100 for manufacturing the composite filament 24 aimed to an additive manufacturing application or a winding application.

In reference to FIGS. 2 and 3, the method 100 comprises a plurality of steps S102, S104, S106, S107, S108 and S109. Said steps will be described within the established order.

A first step S102 of providing a roving or a thread of fibers 26 in various instances by unrolling a bobbin containing the thread.

A step S104 which consists of impregnating the thread with the liquid reactive thermoplastic resin 28. In fact, the impregnation is made with the thermoplastic resin 28 being in a liquid state. In various instances, the liquid resin has a dynamic viscosity being under 1 Pa·s (Poiseuille).

Furthermore, the impregnation step S104 is made at room temperature, in various instances ranging from 20° C. to 26° C. Hence, the liquid resin is at low temperature.

A step S106 of co-extruding the sheath 30 of thermoplastic material around the uncured impregnated thread 27. Contrary to the previous step S104, the co-extrusion step S106 is performed at a high temperature, in various instances of about 200° C. or 220° C., which is above the melting temperature of the sheath material, i.e., 200° C. or typically around 180° C.

The co-extrusion is in various instances carried out by an extruder comprising a nozzle having a circular or polygonal cross-section.

Furthermore, the sheath material is extruded at a rate of about 10 meters per minute.

Advantageously, the sheath 30 is used to ensure the interfacing between the impregnated thread 27 and a polymer used in an additive manufacturing process such as 3D printing. In this regard, the sheath material of the sheath 30 is selected to be compatible with both the thermoplastic resin 28 of the composite filament 24 and the 3D-printed polymer.

Right after the co-extrusion step S106, one of two steps S107 or S108 can be achieved.

The step S107 consists of solidifying the sheath 30 at least partially before curing the thermoplastic resin 28. In fact, the sheath material has an advantageous capability of at least partially hardening at room temperature right after its co-extrusion (which occurs at a temperature of about 220° C.). In that regard, the sheath 30 acts as a protective layer against deconsolidation of the impregnated thread 27, i.e., dissociation of fibers 26. Added to that, the sheath 30 ensures a constant pressure of the impregnated thread 27, thus advantageously avoiding void growth between fibers and advantageously allowing compensation of cure shrinkage.

Another advantage of the sheath 30 utilization, is enabling easy handling of the filament 24 after its curing. In fact, when sheath 30 is completely cured and being below its melting temperature, i.e., below 180° C., the latter is dry and in stable configuration making the manipulation (incl. winding) of the composite filament 24 simple.

The step S108 consisting of curing the thermoplastic resin 28 can also be carried out right after the co-extrusion step S106, wherein polymerization of said thermoplastic resin 28 occurs, i.e., generating a chemical adhesion with the thread 27, at a lower temperature than the melting temperature of the sheath material, in various instances at a temperature of about 100° C. During polymerization, adhesion of the fibers 26 to the liquid resin 28 is obtained with a controlled kinetics enabling chemical diffusion.

A step S109 following the step S107 of a co-curing step because the sheath 30 is not necessarily completely cured when the thermoplastic resin 28 starts to cure. Advantageously, superior joining properties can be achieved between the thermoplastic resin 28 and the sheath 30 through chemical diffusion or dissolution enabling mechanical interlocking, i.e., material blending, which is ensured by in-situ polymerization during the co-curing step S109 and right before a complete polymerization.

During the curing step S108 or the co-coring step S109, it is preferable for the acrylic based formulation to avoid direct contact with oxygen, as it causes the evaporation of monomers and inhibits polymerization.

In a further step (not shown), the composite filament obtained by the method 100 can be used for manufacturing a product by an additive manufacturing or by a winding technique. Thus, the product obtained by the use of the filament can be for example a 3D-printed part or a winded structure.

FIG. 4 is a schematic representation of a machine 200 for manufacturing the composite filament 24. The machine manufactures the filament 24 mainly according to the above-described steps S102, S104, S106, S107, S108 of the method 100. The process is a continuous process and is illustrated here along a general direction that is horizontal. The drawings are schematic and the person skilled in the art would recognize that any other arrangement of the subparts of the machine can be used.

In reference to FIG. 4, a spool holder 34 containing a thread of fibers 26 is configured to unroll the contained thread. Thereafter, an impregnator 36 which is maintained at room temperature impregnates the thread with the thermoplastic resin 28.

The thread of fibers 26 goes through two conical dies 38, 39 that point towards the travel direction of the thread. As matter of fact, the conical die 38 is an inlet for the thread, while the conical die 39 is an outlet die of the impregnator 36.

Advantageously, the two conical dies 38, 39 allow the compaction of the carbon fibers 26 in a round shaped section. Alternatively, any other shape (geometrical or not) can be used.

The impregnator 36 further comprises a chamber 40 preceded and followed by the two conical dies 38, 39. The chamber 40 has an inlet gate 42 for the continuous feeding of the impregnation matrix 28, said feeding is provided by a screw that can be a single or twin screw, or for example a piston enabling to reach a constant air pressure in the chamber 40.

The chamber 40 further comprises an air outlet gate 44 configured to evacuate the air introduced into the chamber 40 during the impregnation and right after the matrix 28 has filled all the micro spaces between each single carbon fiber 26.

Advantageously, the impregnator 36 is designed to adapt the impregnation to the expected thread volume ratio.

The machine 200 further comprises an extruder 46 for co-extruding the sheath 30 of thermoplastic material 32 around the uncured impregnated thread 27.

The extruder 46 is set at a high temperature, i.e., in various instances of about 200° C. or 220° C., which is above the melting temperature of the sheath material 32.

The extruder 46 comprises a chamber 50 with an inlet occupied by a first conical die 48 and an outlet occupied by an outlet die 49. In fact, the conical die 48 is a conical inlet for the impregnated thread 27 to the chamber 50, while the conical die 49 is an outlet die. The two conical dies 48, 49 are pointing toward two opposite directions.

In various instances, the entry conical die 48 is pointing opposite the travel direction of the impregnated thread 27, while the outlet conical die 49 is pointing towards the travel direction of the thread similarly to the orientation of the impregnator's 36 two conical dies 38, 39.

On the one hand, the conical inlet 48 allows the scrapping of the excess of thermoplastic resin 28 from the impregnated thread 27. Advantageously, said scrapping allows to calibrate the impregnated thread 27 while avoiding clogging inside the die 48. Added to that, the excess matrix 28 is pushed outside the die and cannot be accumulated in an area in contact with the impregnated thread 27.

Another advantage of the inlet die 48 is that it thermally isolates the impregnated thread 27 by avoiding its direct contact with the chamber's body 50.

On the other hand, the output die 49 advantageously allows to calibrate the thickness of the co-extruded layer 30 of the sheath material 32.

The feeding of sheath material 32 is provided by a screw that can be a single or twin screw, for example a piston enabling to reach a constant air pressure in the chamber 50. Furthermore, the sheath material 32 is fed at a flow rate that enables the filament to be extruded at a rate of about 10 meters per minute.

The extruder 46 further comprises the nozzle 52 which is in various instances of a circular or polygonal cross-section. For example, the nozzle 52 has the initial form that the impregnated thread 27 has before it enters the extruder 46.

At the exit of the extruder, the fibers are impregnated and coated by the sheath 30, forming a coated filament (as number 23 on FIG. 4) with embedded uncured resin.

The machine 200 further comprises an oven 54 for curing the thermoplastic resin 28 of the coated filament 23.

The oven 54 allows curing below the melting temperature of the co-extruded sheath material 32. In various instances, the temperature in the oven 54 ranges between 90° C. and 120° C. For example, the temperature is about 100° C.

The machine 200 further comprises a puller 56 configured for pulling the filament 24 through all the elements of the machine 200 as well as ensuring thread tensioning, and a winder 58 for winding the filament 24, which is the finished product of the machine 200, at a rate of about 10 meters per minute.

In various instances, the fibers 26 tension is controlled by means of a tensiometer.

It has to be noted that the oven does not necessarily cure the resin completely before the filament is winded up. Actually, the presence of the oven may even be seen as optional, as heat inertia after the sheath co-extrusion could be sufficient to activate the polymerization of the liquid reactive thermoplastic resin.

FIG. 4 further illustrates a magnified partial section 60 of the composite filament 24 where one can see the carbon fibers 26 in the impregnated thread 27, as well as the sheath 30 and the interphase 29.

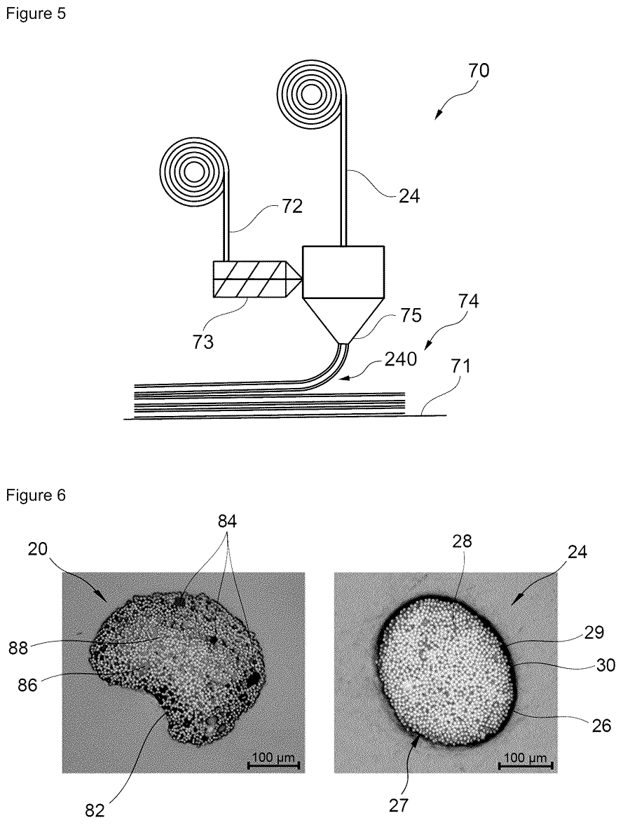

FIG. 5 is an illustration of a 3D printing process with the use of a 3D printing machine 70, commonly known as 3D printer 70, using the composite filament 24.

In reference to FIG. 5, the 3D printer 70 is configured to unwind a bobbin containing the filament 24, along with an additional bobbin containing a filament 72, which is a thermoplastic filament 72.

The 3D printer 70 can co-extrude the latter onto the filament 24 using a co-extrusion die 73. Thus, allowing a joint between the filament 24 of the invention and the thermoplastic filament 72, resulting in the output of a melted filament 240 through the heated 3D printer nozzle 75, the latter is configured to operate displacements in the three dimensions with respect to a horizontal table 71.

As a result, a 3D-printed part 74 is formed from successive layers of the melted filament 240. Advantageously, the 3D-printed part 74 demonstrates an improved material formability and an overall improved material health, i.e., micro voids and air canals are avoided, enabling its use as a technical part from which exceptional material properties are expected. In various instances, the 3D-printed part 74 is used in the automotive, aircraft or space industry.

In addition to the 3D printing process, a winding or weaving technique operated by a winding machine and using a tape made from the composite filament 24 can also be an application to the filament of the invention resulting in the creation of a winded structure. Advantageously, the winded structure is a lightweight composite structure.

FIG. 6 shows a comparison of micrograph cross sections between the filament 20 from prior art (left) and the filament 24 according to the present invention (right).

In reference to the left-hand side of FIG. 6, the filament 20 shows a random and non-homogenous filament section 82 and multiple internal micro-porosities 84, also called micro-voids or air canals. Without being bound by theory, these deficiencies are estimated to be caused by the limits of material formability induced by a thermoset binder 86 that impregnated the fibers 88.

In fact, prior art methods perform the impregnation using a bath which is not an optimal technique because no control of the pressure is applied to the resin or applied by the resin to the fibers can happen. Thus, the process is prone to the creation of micro-voids 84, especially during curing. The shrinkage of said filament 20 thus shows a random section 82.

The right side of FIG. 6 shows a micrograph similar to the illustrated cross section of the filament 24 of FIG. 2, wherein several fibers 26 are displayed being impregnated by the liquid reactive thermoplastic resin 28 forming the impregnated thread 27. The protective sheath 30 can clearly be seen as well as the interphase 29.

The composite filament 24 has a round and homogenous shape. This is observed to be the result of co-extruding a sheath, which allows a good control of the pressure and prevents any shrinkage. The diameter of the circular cross section is comprised between 0.2 mm and 1 mm, and in various instances between 0.3 mm and 1 mm.

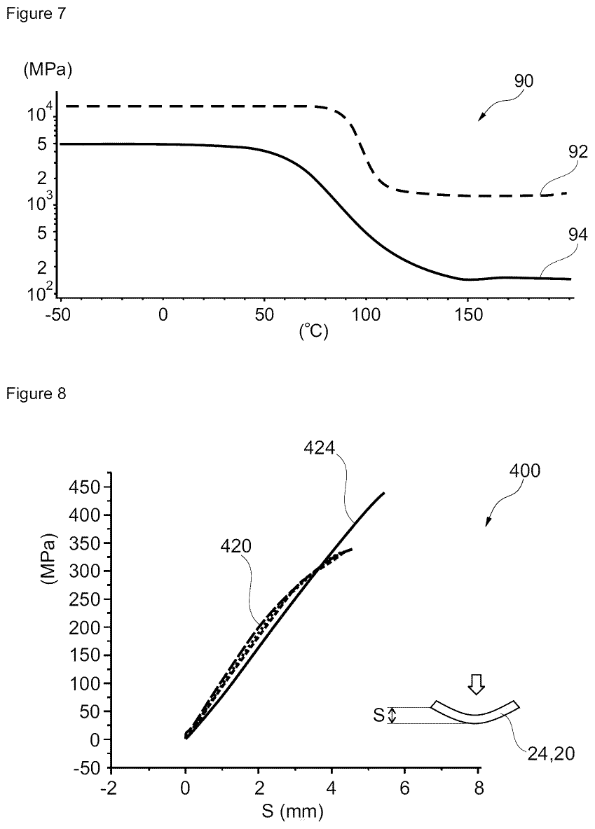

FIG. 7 is a hot formability comparison graph 90 between the filament 20 of prior art and the filament 24 of the invention.

Hot formability is the aptitude of a filament to be easily manipulated as its temperature increases. This is very relevant especially during an additive manufacturing process such as 3D-printing, wherein a nozzle heats the filament prior to use. The vertical axis on the graph represents an image of the effort (MPa) required to deform the material as a function of its temperature.

We observe that the filament 24 of the invention shows an overall better hot formability (curve 94) than the filament 20 of prior art (curve 92), because a smaller effort is required to alter the shape of the filament of the invention.

The constant portions (on the left-and right-hand sides) of the curves correspond to the solid and liquid state respectively.

The curve 92 shows a rapid variation in the temperature range 70-100° C., whereas the curve 94 shows a smoother variation in a wider temperature range of 40-150° C. This means that for a desired hot formability, the margin of error in terms of temperature is greater with the filament of the invention. It is thus easier to control the formability of the filament of the invention.

The graph 400 of FIG. 8 compares the limit flexural stress of the filament of the invention 24 (curve 424) to the limit flexural stress of the known filament 20 (several representative curves 420).

It can be observed that the line 424 expands beyond the line 420, which means that the filament 24 has a higher strain S compared to the one of the filaments 20. This proves that the filament 24 of the invention has a better elasticity and an improved flexural strength.

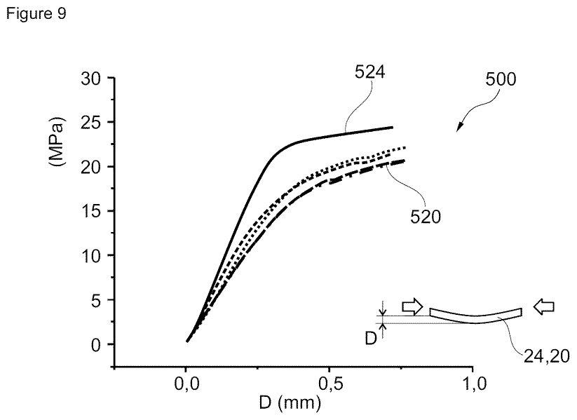

The graph 500 of FIG. 9 compares the interlaminar shear stress of the filament of the invention 24 (curve 524) to the interlaminar shear stress of the known filament 20 (several representative curves 520).

It can be observed that the line 524 expands vertically above the line 520, which means that the filament 24 needs more compression effort to achieve the same displacement D than does the filament 20. This proves that the filament 24 of the invention has a greater interlaminar shear strength.

The mechanical tests confirm that the composite filament of the invention presents superior joining properties between its different components through the combination of chemical and mechanical interlocking obtained by the in-situ polymerization of the thermoplastic resin onto the sheath material.

In fact, pull off mechanical tests consisting of pulling the filament of the invention until its break point have been done. The results of said tests are mainly around 9 MPa. Thus, demonstrating the superior joining properties of the filament.

The composite filament improves the compatibility with a large range of polymers, such as polypropylene (PP), polyamide 6-6 (PA66), by tailoring the co-extruded sheath material during its manufacturing. Thus, enabling the filament to be joined to other polymers in an optimal way during an additive manufacturing process and advantageously presenting improved final properties on an eventual 3D-printed part or a winded structure.

1.-14. (canceled)

15. A method for manufacturing a composite filament aimed to an additive manufacturing application or a winding application, said method comprising, in the following order:
providing a thread of fibers;
impregnating the thread with a liquid reactive thermoplastic resin;
co-extruding a sheath of thermoplastic material around the impregnated thread; and
curing the thermoplastic resin.

16. The method according to claim 15, further comprising:
a step of solidifying the sheath at least partially before curing the thermoplastic resin.

17. The method according to claim 15, wherein the sheath material is extruded at a rate of about 10 meters per minute.

18. The method according to claim 15, wherein the thermoplastic resin is cured at a temperature that is lower than the melting temperature of the sheath.

19. The method according to claim 18, wherein the curing temperature of the thermoplastic resin is around 100° C. and the melting temperature of the sheath is around 200° C.

20. The method according to claim 15, wherein the sheath material is a blend of polymers which solidify at room temperature.

21. The method according to claim 15, wherein the liquid reactive thermoplastic resin is mainly composed of (meth)acrylic polymer, (meth)acrylic monomer and organic peroxides.

22. The method according to claim 15, wherein the thread is made of dry carbon fibers.

23. The method according to claim 15, wherein the co-extrusion is carried out with an extrusion nozzle having a circular or polygonal cross-section.

24. A machine for producing a composite filament, said method comprising:
a spool holder containing a thread,
an impregnator that impregnates the thread with a thermoplastic resin,
an extruder for co-extruding a sheath of thermoplastic material around the uncured impregnated thread,
an oven for curing the thermoplastic resin,
a puller for pulling the filament through all the elements of the machine, and
a winder for winding the filament at a rate of about 10 meters per minute.

25. The machine according to claim 24, wherein the impregnator comprises a chamber having an air outlet gate for evacuating air during the impregnation.

26. The machine according to claim 24, wherein the extruder comprises a conical inlet for scrapping the excess of resin.
